(19) United States
(12) Patent Application Publication
(10) Pub. No.: US 2022/0399765 A1
(43) Pub. Date: Dec. 15, 2022

(54) MAGNETIC LINEAR ACTUATOR

(71) Applicant: National Oilwell Varco, L.P., Houston, TX (US)

(72) Inventor: Geoffrey Pickett, Sugar Land, TX (US)

(21) Appl. No.: 17/776,348

(22) PCT Filed: Nov. 10, 2020
(86) PCT No.: PCT/US2020/059820

§ 371 Date: May 12, 2022

Related U.S. Application Data
(60) Provisional application No. 62/935,422, filed on Nov. 14, 2019.

(51) Int. Cl. H02K 1/17; H02K 5/173

(52) U.S. Cl. CPC H02K 1/17; H02K 5/173

(57) ABSTRACT

A magnetic linear actuator includes a stator, a translator, and a ball bearing. The stator includes a first helical array of magnets. The translator is disposed within the stator, and includes a second helical array of magnets. The ball bearing is disposed between the stator and the translator, and includes a plurality of balls in contact with the stator.

### CROSS-REFERENCE TO RELATED APPLICATIONS

This application is a U.S. national phase application under 35 U.S.C. § 371 of international application No. PCT/US2020/059820, filed Nov. 10, 2020, entitled “Magnetic Linear Actuator,” which claims priority to U.S. Provisional Patent Application No. 62/935,422, filed Nov. 14, 2019, entitled “Magnetic Linear Actuator,” all of which are hereby incorporated herein by reference in their entirety.

### BACKGROUND

A linear actuator is a device that creates straight line motion. Various techniques are employed to produce linear motion. Some linear actuators apply hydraulic pressure to move a piston. Other implementations of a linear actuator convert rotary motion into linear motion. For example, a threaded shaft, or a nut or roller screw assembly coupled to the threaded shaft, may be rotated to longitudinally extend or retract the shaft. An electric motor may provide the rotation needed to translate the shaft.

### SUMMARY

Magnetic linear actuators that include a ball bearing between the translator and stator that reduces the size of the air gap between the magnet arrays of the translator and stator are disclosed herein. In one example, a magnetic linear actuator includes a stator, a translator, and a first ball bearing. The stator includes a first helical array of magnets. The translator is disposed within the stator, and includes a second helical array of magnets. The first ball bearing is disposed between the stator and the translator, and includes a plurality of balls in contact with the stator. The stator includes a layer of conductive material coupled to the first helical array of magnets, and the balls are in contact with the layer of conductive material. The first ball bearing is secured to the translator. The first ball bearing includes an inner race secured to the translator, and the balls are in contact with the inner race. The first helical array of magnets may include magnets arranged as a Halbach array. The second helical array of magnets may include magnets arranged as a Halbach array. The translator is configured to move longitudinally within the stator responsive to rotation of the stator. The first ball bearing is disposed at a first end of the translator, and the magnetic linear actuator also includes a second ball bearing disposed between the stator and the translator at a second end of the translator.

In another example, a magnetic linear actuator includes a stator, a translator, and a first ball bearing. The stator includes a helical array of magnets, and is configured to rotate. The translator includes a helical array of magnets, and is configured to convert rotary motion to linear motion and move longitudinally within the stator responsive to rotation of the stator. The first ball bearing is disposed in an air gap between the stator and the translator. The first ball bearing includes a plurality of balls configured to rotate in a first direction responsive to rotation of the stator, and to rotate in a second direction responsive to longitudinal motion of the translator. The first ball bearing includes an inner race secured to the translator, and the balls are in contact with the inner race. The stator includes a layer of conductive material covering the first helical array of magnets. The layer of conductive material is in contact with the balls and is configured to retain the balls in the inner race. The first helical array of magnets may include magnets arranged as a Halbach array. The second helical array of magnets may include magnets arranged as a Halbach array. The first ball bearing is disposed at a first end of the translator, and the magnetic linear actuator includes a second ball bearing disposed in the air gap between the stator and the translator at a second end of the translator.

In a further example, a method for magnetic linear actuation includes rotating a stator comprising a first helical array of magnets. A translator, comprising a second helical array of magnets, is longitudinally translated within the stator responsive to rotation of the stator. An air gap between the first helical array of magnets and the second helical array of magnets is maintained via a ball bearing disposed between the stator and the translator. Balls of the ball bearing roll in a first direction responsive to rotating the stator. The balls of the ball bearing roll in a second direction responsive to longitudinally translating the translator with the stator. The balls roll on a layer of conductive material disposed between the first helical array of magnets and the ball bearing. The balls are retained in an inner race coupled to the translator by contact of the balls with the layer of conductive material. Magnets of the first helical array may be arranged as a Halbach array. Magnets of the second helical array may be arranged as a Halbach array. Rolling the balls in the first direction includes rolling the balls about a circumference of the layer of conductive material. Rolling the balls in the second direction includes rolling the balls along the layer of conductive material from a first end of the stator to a second end of the stator.

### BRIEF DESCRIPTION OF THE DRAWINGS

For a detailed description of various examples, reference will now be made to the accompanying drawings in which:

FIG. 1 shows a partially sectional view of a magnetic linear actuator in a retracted position in accordance with the present disclosure;

FIG. 2 shows a partially sectional view of a magnetic linear actuator in an extended position in accordance with the present disclosure;

FIG. 3 shows a side view of a translator of a magnetic linear actuator in accordance with the present disclosure;

FIG. 4 shows a perspective, sectional view of a stator of a magnetic linear actuator in accordance with the present disclosure;

FIG. 5 shows an example magnet array in which the magnets are arranged in a north-south orientation;

FIG. 6 shows an example magnet array in which the magnets are arranged as a Halbach array;

FIGS. 7A and 7B show examples of magnets arranged as a helical Halbach array on a stator and translator of a magnetic linear actuator in accordance with the present disclosure; and

FIG. 8 shows a flow diagram for a method for magnetic linear actuation in accordance with the present disclosure.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment. The exemplary embodiments presented herein, or any elements thereof, may be combined in a variety of ways, i.e., any element from one exemplary embodiment may be used in any other exemplary embodiment, without departing from the scope of the disclosure.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis.

Linear actuators that convert rotary motion generated by an electric motor to linear motion are subject to a number of limitations. For example, the linear force produced by such actuators is generally lower than the force provided by a hydraulic device, friction between the various components of such actuators limits the life of the actuator, and the cost may be relatively high.

Magnetic linear actuators reduce or eliminate friction between parts by using interaction of magnetic fields to convert rotary motion to linear motion. The magnetic linear actuators disclosed herein include a translator and stator, each of which includes a helical array of magnets producing a magnetic field. Rotation of one of the translator or stator, induces linear motion of one or the other of the translator or stator by interaction of the magnetic fields. For example, rotation of the translator may induce linear motion of the translator or the stator to maintain alignment of the magnetic fields. To reduce the size of the air gap between the translator and stator, and thereby increase the strength of the magnetic flux between the translator and stator, the magnetic linear actuators of the present disclosure include a ball bearing disposed between the translator and stator. The ball bearing provides for both rotary and linear movement with low friction while maintaining a relatively small air gap between the translator and stator.

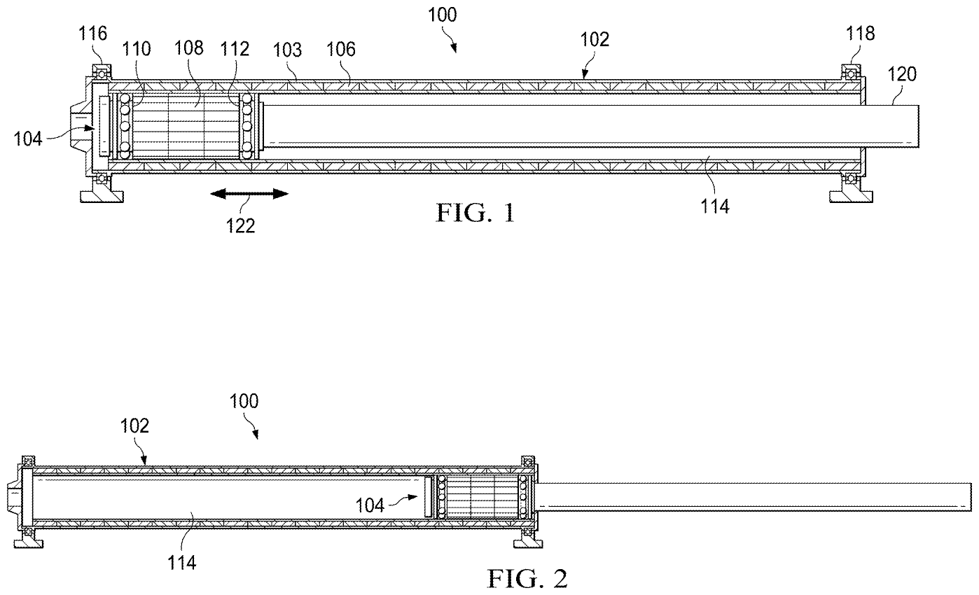

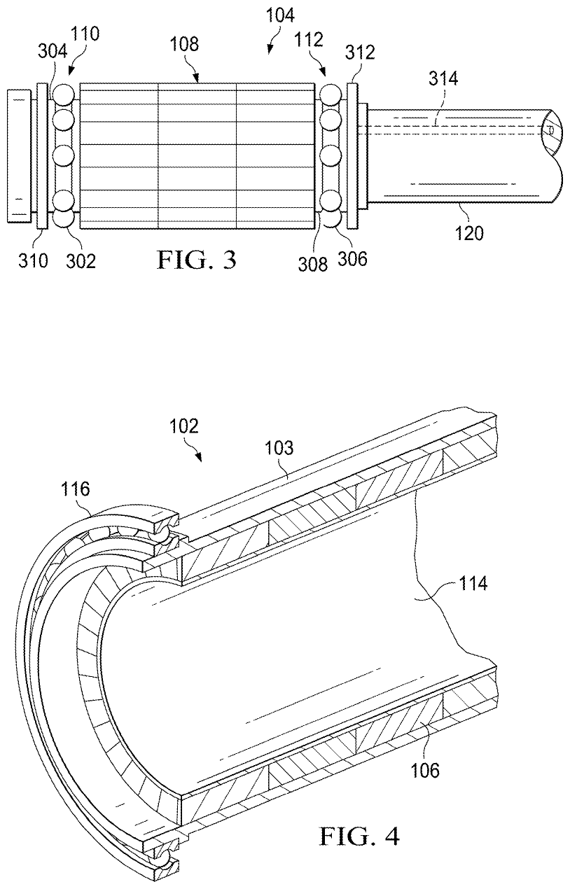

FIG. 1 shows a partially sectional view of a magnetic linear actuator 100 in a retracted position in accordance with the present disclosure. The magnetic linear actuator 100 includes a stator 102, a translator 104, a ball bearing 110, and a ball bearing 112. The stator 102 includes an outer shell 103, magnets 106 arranged in a helical array within the outer shell 103, and layer of conductive material 114 covering the magnets 106 and forming an inner surface of the stator 102. The outer shell 103 may be generally cylindrical in shape. The layer of conductive material 114 is formed of conductive steel or other conductive material, such as HIPERCO alloy, in some examples of the stator 102. Some implementations of the stator 102 include a bearing 116 and a bearing 118. The stator 102 rotates on the bearing 116 and the bearing 118. In such implementations, the stator 102 may be referred to as a rotating stator. FIG. 4 shows a perspective, sectional view of the stator 102.

The translator 104 is disposed within the bore of the stator 102. The bore and the translator 104 may be generally cylindrical in shape. The translator 104 includes magnets 108 arranged in a helical array disposed on the outer circumference of the translator 104. A shaft 120 extends from the translator 104 in some implementations of the magnetic linear actuator 100. An end of the shaft 120 may be fixed to prevent rotation while allowing linear motion in the direction 122. Interaction of the magnetic fields produced by the magnets 106 and the magnets 108 cause the translator 104 to move longitudinally (in the direction 122) responsive to rotation of the stator 102. In FIG. 1, the translator 104 is disposed at a first end of the stator 102 (i.e., the translator 104 is retracted), and in FIG. 2, the translator 104 is disposed at a second end of the stator 102 (i.e., the translator 104 is extended). For example, rotation of the stator 102 in a first direction may cause the translator 104 to move longitudinally within the stator 102 from the first end of the stator 102 to the second end of the stator 102, and rotation of the stator 102 in a second direction (opposite the first direction) may cause the translator 104 to move longitudinally within the stator 102 from the second end of the stator 102 to the first end of the stator 102.

The magnetic field strength between the stator 102 and the translator 104 (and the force produced by linear movement of the translator 104 within the stator 102) is increased by reducing the air gap between the magnets 106 and the magnets 108. As the size of the air gap is reduced, eccentricity (deflection) of the translator 104 is increasingly likely to cause the magnets 108 to contact the inner surface of the stator 102, and damage the stator 102 and/or the translator 104. To prevent such damage, the ball bearing 110 and the ball bearing 112 are disposed between the stator 102 and the translator 104, and hold the distance between the stator 102 and the translator 104 constant, thereby allowing the air gap to be reduced and increasing the magnetic field strength between the stator 102 and the translator 104. For example, the air gap may be in a range of 0.006 inches to 0.10 inches. Material used in the inner surface of the stator 102 may include HIPERCO alloys or other magnetic steel.

FIG. 3 shows a side view of the translator 104. The ball bearing 110 and the ball bearing 112 are secured to the translator 104. The ball bearing 110 is disposed at a first end of the translator 104, and the ball bearing 112 is disposed at a second end of the translator 104. The ball bearing 110 includes an inner race 304 that is secured to the translator 104, and a plurality of balls 302 that roll in a channel or groove of the inner race 304. The balls 302 are constrained by the inner race 304 and the layer of conductive material 114 of the stator 102. That is, contact of the balls 302 with the layer of conductive material 114 holds the balls 302 in the inner race 304. Thus, the balls 302 are free to roll on the layer of conductive material 114 about the inner circumference of the stator 102 as the stator 102 rotates, and to roll on the layer of conductive material 114 in the direction 122 as the rotation of the stator 102 causes the translator 104 to move longitudinally within the stator 102. The balls 302 may be formed of a ceramic material in some implementations of the magnetic linear actuator 100. The ball bearing 112 includes balls 306 and inner race 308 that are functionally similar to the balls 302 and inner race 304 of the ball bearing 110.

In some implementations of the translator 104, the shaft 120 includes a channel 314 for providing a lubricant to the ball bearing 110 and the ball bearing 112. A lubricant may flow through the channel 314 and pass through one or more orifices in the translator 104 to lubricate the ball bearing 110 and the ball bearing 112. The translator 104 includes a retainer 310 disposed at a first end of the translator 104, and a retainer 312 disposed at a second end of the translator 104 to hold the lubricant proximate the translator 104 (between the retainer 310 and the retainer 312), that is to prevent dispersion of the lubricant within the stator 102. The retainer 310 and the retainer 312 may be formed of a polymer material, and maintain contact with the layer of conductive material 114.

The shaft 120 may also include a passage that allows for movement of air from one end of the translator 104 to the other so that air pressure between an end of the translator 104 and an end of the stator 102 does not resist movement of the 104.

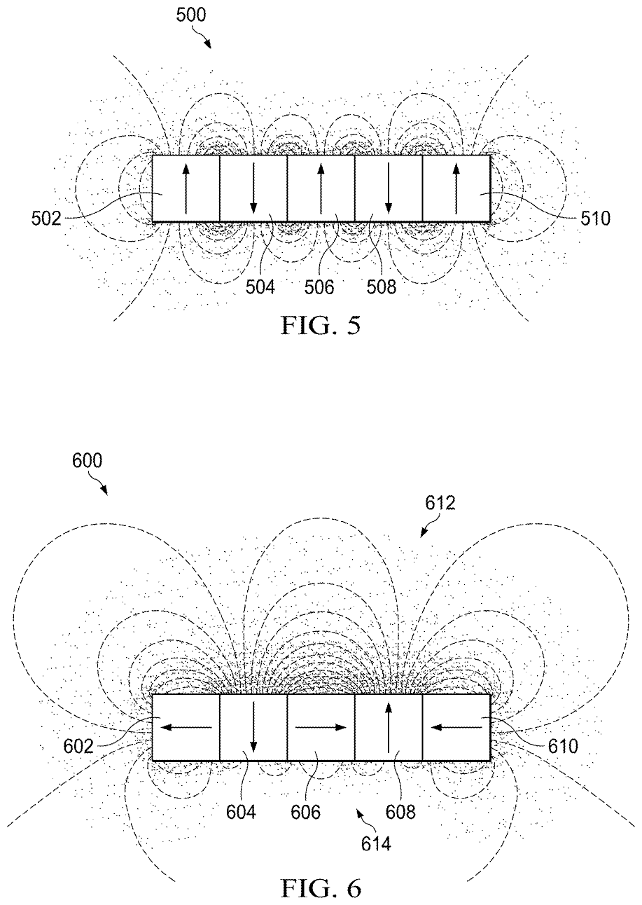

In some implementations of the stator 102 and the translator 104, the magnets 106 and the magnets 108 are arranged as Halbach arrays. FIG. 5 shows an example magnet array 500 in which the magnets 502-510 are arranged in a north-south orientation. The magnets 502, 506, and 510 are oriented in one direction, and the magnets 504 and 508 are oriented in the opposite direction. In a Halbach array, the magnets are not arranged in a north-south orientation or alternating polarity as in the magnet array 500. Rather, in a Halbach array, the magnets are arranged in a north-east-south-west orientation that pushes the flux of the array in one direction. Because flux density and linkage are important to increasing performance in electric rotating machines, the Halbach array is very advantageous.

FIG. 6 shows an example Halbach array 600. The Halbach array 600 includes magnets 602-610, where each successive magnet is rotated 90° counterclockwise with respect to the previous magnet (e.g., magnet 604 is rotated 90° counterclockwise with respect to magnet 602, magnet 606 is rotated 90° counterclockwise with respect to magnet 604, etc.). This arrangement increases the magnet flux on side 612 of the of the Halbach array 600, and decreases the magnetic flux on the side 614 of the Halbach array 600. In an implementation of the stator 102, a side of the magnets 106 nearest the translator 104 corresponds to the side 612 of the Halbach array 600, and in an implementation of the translator 104, the side of the magnets 108 nearest the stator 102 corresponds to the side 612 of the Halbach array 600.

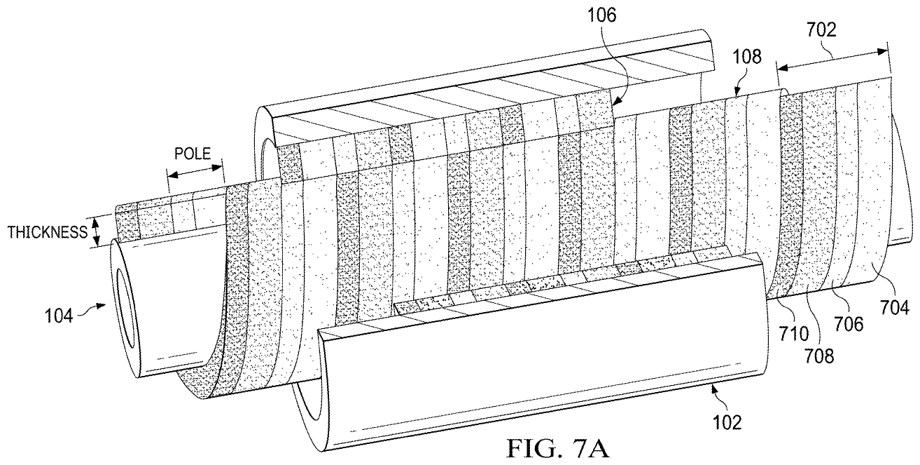

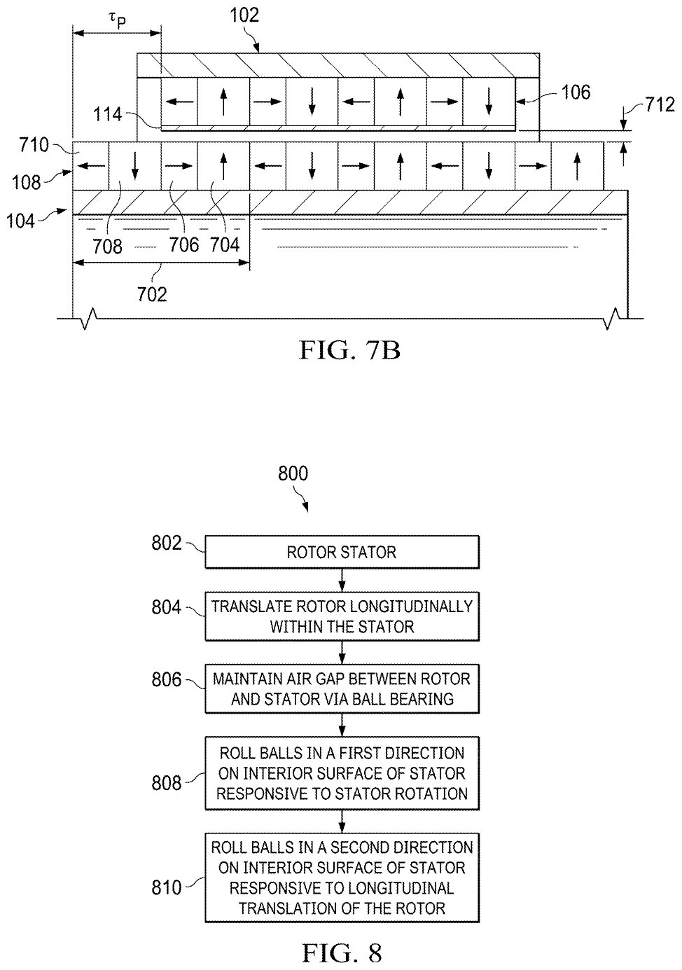

FIGS. 7A and 7B show a portion of the stator 102 with magnets 106 arranged as a helical Halbach array, and a portion of the translator 104 with magnets 108 arranged as a helical Halbach array. A set of four helical bands 702 forms a Halbach array, where each band includes magnets oriented in one of the four orientations that make up the Halbach array. For example, helical band 704 includes only magnets with north orientation, helical band 706 includes only magnets with east orientation, helical band 708 includes only magnets with south orientation, and helical band 710 includes only magnets with west orientation. FIG. 7B shows alignment of the magnets 106 and the magnets 108. As the 102 rotates, the 104 is displaced to maintain the illustrated alignment of the magnets 106 and the magnets 108. As explained above, the ball bearings 110 and 112 maintain the air gap 712 between the stator 102 and the translator 104.

FIG. 8 shows a flow diagram for a method 800 for magnetic linear actuation in accordance with the present disclosure. Though depicted sequentially as a matter of convenience, at least some of the actions shown can be performed in a different order and/or performed in parallel. Additionally, some implementations may perform only some of the actions shown. Operations of the method 800 may be performed by an implementation of the magnetic linear actuator magnetic linear actuator 100.

In block 802, the stator 102 is rotated. For example, an electric motor coupled to the stator 102 may be activated to rotate the stator 102.

In block 804, rotation of the stator 102 cause the translator 104 to move longitudinally within the stator 102. That is interaction of the magnetic fields generated by the magnets 106 and the magnets 108 causes the translator 104 to move longitudinally with the stator 102 to maintain alignment of the magnetic fields as the stator 102 rotates.

In block 806, the ball bearing 110 and the ball bearing 112 maintain an air gap between the stator 102 and the translator 104 by restricting eccentricity of the translator 104.

In block 808, the balls 302 of the ball bearing 110 roll in a first direction (about the inner circumference) on the interior surface of the stator 102 (i.e., the layer of conductive material 114) responsive to rotation of the stator 102.

In block 810, the balls 302 of the magnetic linear actuator 100 roll in a second direction (from a first end of the stator 102 to a second end of the stator 102) responsive to longitudinal translation of the translator 104 within the stator 102.

While an implementation of the magnetic linear actuator 100 has been described having ball bearing secured to the translator 104 and a layer of conductive material 114 in the stator 102, some implementations of the magnetic linear actuator 100 may secure the ball bearings to the inner surface of the stator and provide a conductive layer over the magnet array of the translator. In such implementations, stator may be shorter than translator, and the magnet array of the stator may be shorter than the magnet array of the translator.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A magnetic linear actuator, comprising:
a stator comprising a first helical array of magnets;
a translator disposed within the stator, and comprising a second helical array of magnets; and
a ball bearing disposed between the stator and the translator, and comprising a plurality of balls in contact with the stator.

2. The magnetic linear actuator of claim 1, wherein the stator comprises a layer of conductive material coupled to the first helical array of magnets, and wherein the balls are in contact with the layer of conductive material.

3. The magnetic linear actuator of claim 2, wherein the ball bearing comprises an inner race secured to the translator, and wherein the balls are in contact with the inner race.

4. The magnetic linear actuator of claim 1, wherein the ball bearing is secured to the translator.

5. The magnetic linear actuator of claim 1, wherein:
the first helical array of magnets comprises magnets arranged as a Halbach array; and
the second helical array of magnets comprises magnets arranged as a Halbach array.

6. The magnetic linear actuator of claim 1, wherein the translator is configured to convert rotary motion to linear motion, and move longitudinally within the stator responsive to rotation of the stator.

7. The magnetic linear actuator of claim 1, wherein:
the ball bearing is a first ball bearing:
the first ball bearing is disposed at a first end of the translator; and
the magnetic linear actuator comprises a second ball bearing disposed between the stator and the translator at a second end of the translator.

8. A magnetic linear actuator, comprising
a stator comprising a helical array of magnets, and configured to rotate;
a translator comprising a helical array of magnets, and configured to convert rotary motion to linear motion and move longitudinally within the stator responsive to rotation of the stator; and
a ball bearing disposed in an air gap between the stator and the translator, and comprising a plurality of balls configured to:
rotate in a first direction responsive to rotation of the stator; and
rotate in a second direction responsive to longitudinal motion of the translator.

9. The magnetic linear actuator of claim 2, wherein the ball bearing comprises an inner race secured to the translator, and wherein the balls are in contact with the inner race.

10. The magnetic linear actuator of claim 8, wherein the stator comprises a layer of conductive material covering the first helical array of magnets, and wherein the layer of conductive material is in contact with the balls and configured to retain the balls in the inner race.

11. The magnetic linear actuator of claim 8, wherein:
the first helical array of magnets comprises magnets arranged as a Halbach array; and
the second helical array of magnets comprises magnets arranged as a Halbach array.

12. The magnetic linear actuator of claim 8, wherein:
the ball bearing is a first ball bearing;
the first ball bearing is disposed at a first end of the translator; and
the magnetic linear actuator comprises a second ball bearing disposed in the air gap between the stator and the translator at a second end of the translator.

13. The magnetic linear actuator of claim 8, wherein the translator comprises a channel therethrough configured to direct a lubricant to the ball bearing.

14. The magnetic linear actuator of claim 8, wherein the translator comprises a retainer in contact with the stator, and configured to maintain the lubricant at the translator.

15. A method for magnetic linear actuation, comprising:
rotating a stator comprising a first helical array of magnets;
longitudinally translating a translator, comprising a second helical array of magnets, within the stator responsive to rotation of the stator;
maintaining an air gap between the first helical array of magnets and the second helical array of magnets via a ball bearing disposed between the stator and the translator;
rolling balls of the ball bearing in a first direction responsive rotating the stator; and
rolling the balls of the ball bearing in a second direction responsive to the longitudinally translating the translator with the stator.

16. The method of claim 15, further comprising rolling the balls on a layer of conductive material disposed between the first helical array of magnets and the ball bearing.

17. The method of claim 16, further comprising retaining the balls in an inner race coupled to the translator by contact of the balls with the layer of conductive material.

18. The method of claim 16, wherein:
rolling the balls in the first direction comprises rolling the balls about a circumference of the layer of conductive material; and
rolling the balls in the second direction comprises rolling the balls along the layer of conductive material from a first end of the stator to a second end of the stator.

19. The method of claim 15, wherein magnets of the first helical array are arranged as a Halbach array.

20. The method of claim 15, wherein magnets of the second helical array are arranged as a Halbach array.
